(19) United States
(12) Patent Application Publication
(10) Pub. No.: US 2025/0043588 A1
(43) Pub. Date: Feb. 6, 2025

(54) SUN SHADE

(71) Applicant: Kelly Beam, Charleston, SC (US)

(72) Inventor: Kelly Beam, Charleston, SC (US)

(21) Appl. No.: 18/922,622

(22) Filed: Oct. 22, 2024

Related U.S. Application Data
(63) Continuation-in-part of application No. 17/870,905, filed on Jul. 22, 2022, now Pat. No. 12,139,924.

(51) Int. Cl. E04H 15/40

(52) U.S. Cl. CPC E04H 15/40

(57) ABSTRACT

A sun shade blocks or inhibits ultraviolet radiation emitted by the sun from reaching the head of a user. Positioning of supporting stations of the sun shade relative to a base is adjustable so that shading provided by a canopy of the sun shade can be user selected. Positioning of the canopy along the stanchions may also be adjustable. The sun shade is usable as a stand alone device, or it may be attached to other devices such as beach chairs or lounge chairs.

This Application is a continuation in part of application Ser. No. 17/870,905, filed Jul. 22, 2022 upon which Applicant claims priority.

### SUMMARY OF THE INVENTION

The present invention is a sun shade. The sun shade is constructed to block or inhibit ultraviolet radiation from the sun from reaching the head of a user. The portable sun shade has a base. The base is formed with a first rib and a second rib that is positioned generally parallel to the first rib. Each rib has a plurality of receptacle apertures. The width of the base is adjustable to mount to beach chairs or lawn chairs.

A canopy covers at least a portion of the base. A first arcuate stanchion a second arcuate stanchion extend through the canopy to support the canopy that is elevated above the base and supported by the stanchions. The ends of the stanchion are held within receptacle apertures of the first rib and the second rib. Positioning of the arcuate stanchions within the receptacle apertures is user selectable so that shading or coverage of the user by the canopy may be varied. Positioning of supporting stations of the sun shade relative to the base are adjustable so that shading provided by the canopy of the sun shade can be user selected. The sun shade is usable as a stand-alone device, or it may be attached to other devices such as beach chairs or lounge chairs.

### DESCRIPTION OF THE DRAWINGS

FIG. 1 shows elements of the sun shade according to an embodiment of the invention.

FIG. 2 is front, perspective view of the assembled sun shade.

FIG. 3 is a side, perspective view of the assembled sun shade.

FIG. 4 is another front, perspective view of the assembled sun shade.

FIG. 5 is an isolation of an inside of a canopy of the sunshade demonstrating a pocket formed in the canopy.

FIG. 6 is a side, perspective view of the assembled sun shade with the canopy repositioned from the view shown in FIG. 3.

FIG. 7 shows the base for the sun shade in isolation, with stanchions mounted in receptacle apertures formed in the ribs of the base.

FIG. 8 is a perspective view of the sun shade mounted to a chair and the canopy opened on one side of the sun shade.

FIG. 9 is a perspective view of the sun shade mounted to a chair and the canopy positioned as shown in FIG. 6.

FIG. 10 is a top view of the base of the sun shade.

FIG. 11 shows a top plan view of the sun shade disassembled from its configuration in use and assembled for transport.

FIG. 12 is front, perspective view of the assembled sun shade according to another embodiment of the invention.

FIG. 13 is another front, perspective view of the repositioned base of the sun shade according to the embodiment of the invention shown in FIG. 12.

FIG. 14 is side, perspective view of the assembled sun shade according to the embodiment of the invention shown in FIG. 12.

FIG. 15 is a side, perspective view of the assembled sun shade with the canopy repositioned from the view shown in FIG. 14.

FIG. 16 is a perspective view of the sun shade according to the embodiment of the invention shown in FIG. 12, with the sun shade mounted to a chair and the canopy opened on one side of the sun shade.

### DESCRIPTION OF PREFERRED EMBODIMENTS

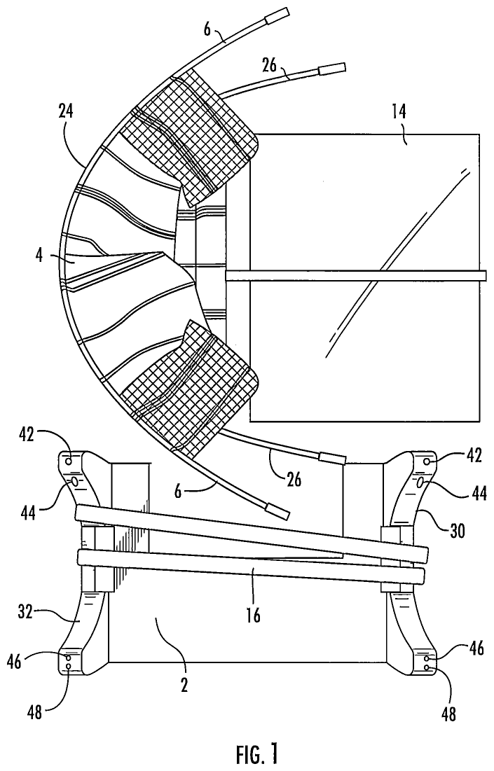

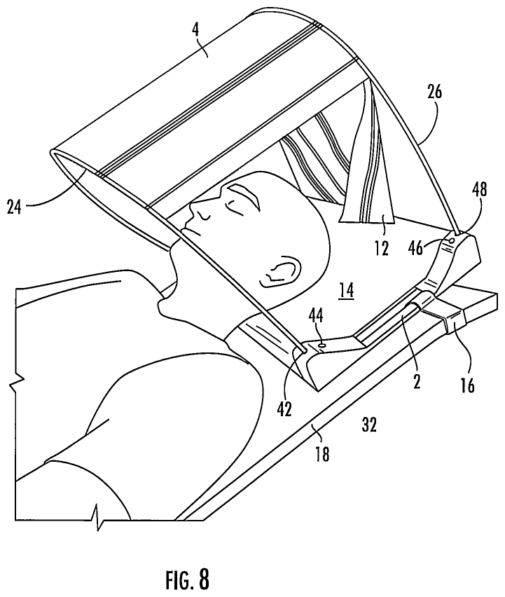

An embodiment of the sun shade, as shown in FIG. 1, provides a base 2. A canopy 4 is provided that is supported by arcuate stanchions 6,26. The canopy is slidable along the arcuate stanchions for adjusting the position of the canopy to open and close portions of the canopy. FIG. 8. Channels 24 may be formed in the canopy near a front and a rear of the canopy through which the arcuate stanchion are positioned, and which facilitate sliding of the canopy along the stanchions. The canopy may also comprise a back panel 12 in addition to a top enclosure. A pillow or cushion 14 may overlay the base of the sun shade.

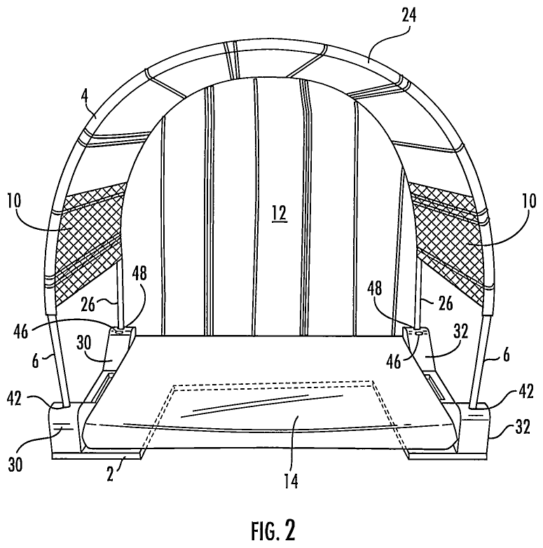

FIG. 2 shows an embodiment of the assembled sun shade. The arcuate stanchions 6 are positioned within receptacles 42 that are formed in a first rib 30 and a second rib 32 that are generally parallel to each other, and extend upwardly from the base 2 at the front and rear of the base in this embodiment. The canopy 4 is mounted to the arcuate stanchions to form a tent like structure with a top covering and optionally, a back panel 12. The pillow 14 may be positioned over the base between the stanchions that are present on opposite sides of the base. In this embodiment, two arcuate stanchions are used. One stanchion is positioned in the receptacle apertures 42,44 at a front of the canopy and the other stanchion is positioned in the one of the receptable apertures 46,48 at a rear of the canopy when the canopy is positioned as shown in FIG. 2. A first end of one of the two stanchions 6,26 is positioned in a receptacle aperture that is formed in a rib 30 extending from one side of the base and the opposite end of the stanchion is positioned in a receptacle aperture that is formed in a rib 32 that is present on the opposite side of the base. A first end of the other stanchion is positioned in a receptacle aperture that is formed in rib 30 on one side of the base and the opposite end of the other stanchion is positioned in a receptacle aperture that is formed in the rib 32 on the opposite side of the base.

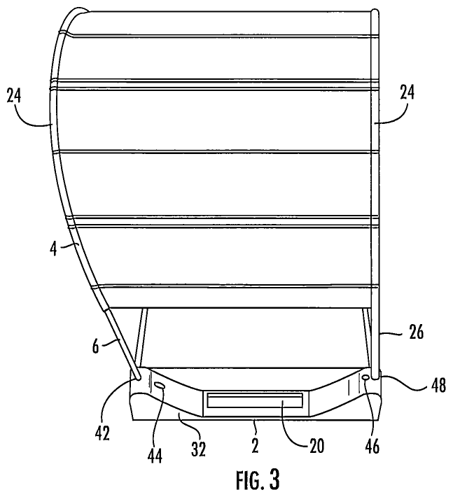

FIG. 3 shows a view taken from above and from a side of the sun shade. As shown in FIG. 3, the front stanchion 6 is angled away from the back stanchion. Receptacle apertures 42 are formed at an angle in ribs 30,32 so that the canopy that extends forward and past the front of the base 2 of the sun shade. This angle is preferred to be between twenty and forty degrees (20°-40°) from a vertical positioning of the front stanchion. The inventor has discovered that even a relatively small angle that provides a longer canopy at the top can provide substantially greater shade coverage to the user's face as compared to a vertical mounting of the stanchions. At the same time, the user's useful view from within the sun shade is not materially inhibited by this angle. This is particularly true with some angles of the sun, or with angles of a back of a beach or lounge chair in combination with angles of the sun. FIG. 8 demonstrates the sun shade attached to a lounge chair 18, such as by straps 16, with stanchion 6 positioned in receptacle aperture 42 so that the stanchion 6 is angled forward, and toward the user's torso, and in this embodiment, beyond the base.

Receptacle apertures 44 are formed so that when these apertures are selected, stanchion 6 extends vertically from the ribs 30,32 of the base. Positioning of the arcuate stanchion 6 within the receptacle apertures, 42, 44 or 46, is user selectable, so that shading or coverage of the user by the canopy is variable.

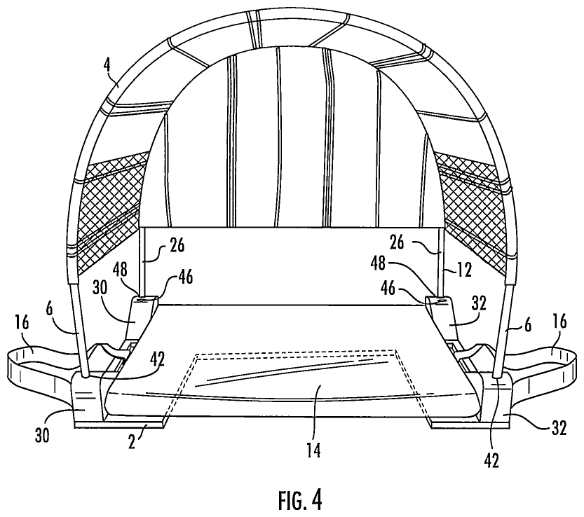

As shown in FIG. 8, the degree to which the sides of the canopy 4 occlude light is adjustable. The relative length of the sides of the canopy is adjusted by the sliding the channels 24 of the canopy along the arcuate stanchions 6, 26. One side or both sides may slide along the stanchions to adjust the length of the sides. The formation of the canopy of cloth or similar material means that the canopy material will fold against itself as it is pushed upwardly along the stanchions. The coverage of the canopy material may be selected when the canopy is produced. In the embodiments of FIG. 2 and FIG. 4, the canopy may be positioned by sliding along the arcuate stanchions so that one side is substantially fully occluded or blocked, while the other side is mostly open as shown in FIG. 8.

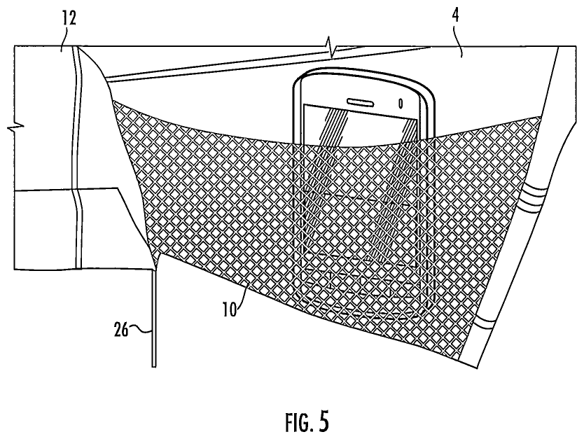

The back panel 12 is affixed to a top portion of the sun shade. As shown in FIG. 5, the back panel of the sun shade can be rolled or folded up if full covering of the back panel from the top of the canopy to the base is not desired. The back panel can be held in an open or partially open position relative to the canopy by hook and loop material, snaps or strips of fabric, or other materials.

As shown in FIG. 2, pockets 10 may be provided on the interior of the canopy 4. The pockets may be formed of a mesh material that is attached to the canopy. Since the sun shade is useful at beaches, pools and the like while sun bathing, having pockets available on the interior of the sun shade is very handy. Attire worn in such settings does not typically lend itself to having pockets within clothing. By having the pockets on the interior of the sun shade, personal effects placed within the pockets are not publicly visible. FIG. 5 shows a close-up view of a pocket attached to one of the sides of the canopy.

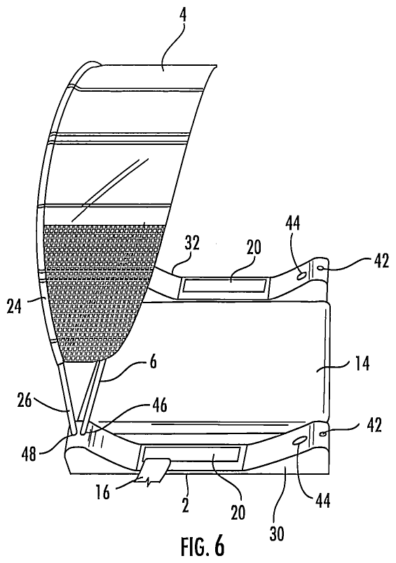

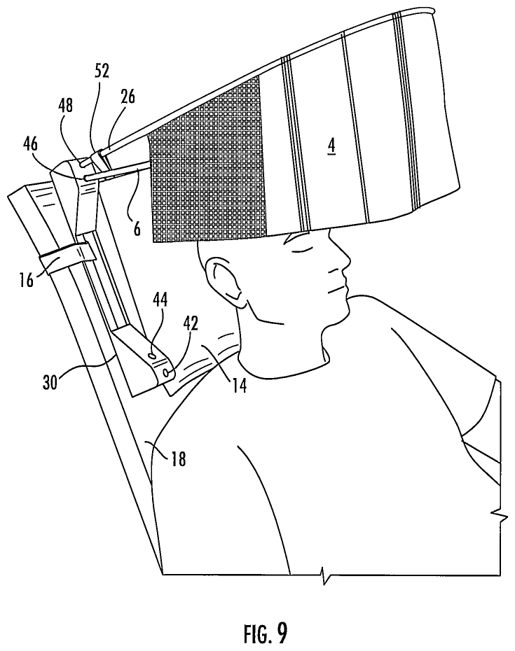

FIG. 6 shows that the front stanchion 6 may be removed from the receptacle apertures 42 or 44, and positioned rearwardly. Stanchion 6 is positioned in receptacle apertures 46 formed in ribs 30,32. Receptacle apertures 46 are formed at an angle in ribs 30,32 so that the stanchion extends forward, while receptacle apertures 48 are formed so that stanchion 26 has a vertical orientation. The angle of receptacle apertures 46 is preferred to be between ten and thirty degrees (10°-30°) from a vertical positioning. Receptacle apertures 46 allow stanchion 6 to be positioned rearwardly, providing more exposure of the user's head and face, as shown in FIG. 9. When attached to a lounge chair 18 as shown, this position protects the user's head and perhaps neck from direct sunlight when, for example, the sun is substantially overhead. The user's view is not blocked by the sun shade, and substantial ventilation is available.

Additional receptacles of varying angles may be provided in the ribs 30,32 positioning of the stanchions 6,26 to provide additional user selectivity in positioning the canopy or rear stanchions in various places as desired by users. In yet another embodiment, the receptables are slidable along the base for movement of the stanchions to desired positions. The receptacles slide along the base, but may be locked in position as desired.

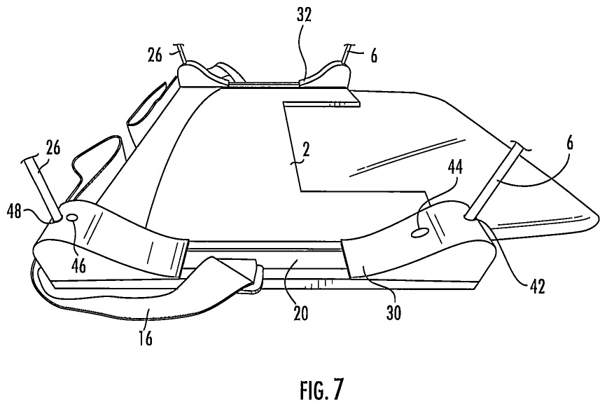

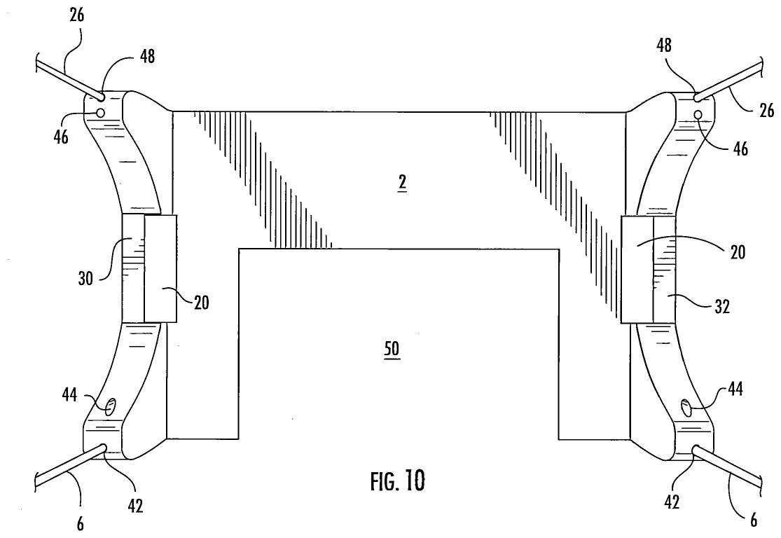

FIGS. 7 and 10 show the base 2 for the sun shade in isolation, with the stanchions 6,26 mounted in receptacles 42, 48. Straps 16 for mounting the sun shade to a beach chair, lounge chair 18 or other item may be connected to the base and the chair or other item as shown in the drawings. Hand holds 20 are provided for carrying the sun shade. The hand holds may be formed in the ribs 30,32 or the base 2 itself.

In a preferred embodiment, the base 2 is formed with ribs 30,32 present on opposite sides of the base. Each rib has two tumids or humps formed in the base, with one hump present near each end of the rib. Each hump may have an arcuate surface that reduces the size of the ribs near the center of the ribs. The hand holds 20 may be formed between the humps of each rib, and at a portion of the ribs that is reduced in size from the humps. Receptacle apertures 42, 44, 46 and 48 as described are formed in the humps, as shown in the drawings.

FIG. 8 shows the sun shade in use and mounted to a lounge chair 18. In this embodiment, the position of the canopy 4 is changed by sliding the canopy along the arcuate stanchions 6. A side of the canopy has been positioned so that it is in the fully down position to block such on that side. In this embodiment, when positioned with one side fully down, the opposite side is partially open. A user may desire to have one side or other of the sun shade fully blocked when the angle of the sun is such that this position provides the most sun protection. However, the opposite side is partially open as shown in FIG. 8, which provides ventilation. Having one side open also allows the user to more easily communicate with people on the open side, and also provides visibility on that side.

The back panel 12 of the canopy 4 is prepared to be releasably attached to the base. Hook and loop material or another fastener such as snaps may be affixed to the rear of the base 2 and the back panel 12 of the canopy 4 to secure the back panel of the canopy in position. If ventilation is desired through the back panel, the back panel can be rolled or folded as shown in FIG. 5, or a portion of the back panel can be released so that the back panel does not attach as shown in FIG. 8.

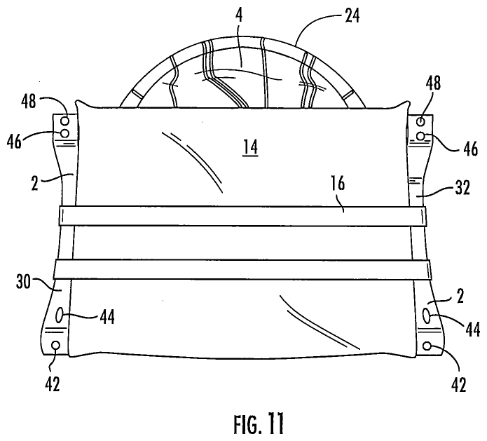

The sun shade may be disassembled, as shown in FIG. 11, and packed. The stanchions 6,26 are removed from the receptacle apertures. The stanchions and canopy 4 positioned horizontally over the base so that the assembly is generally flat. The pillow or cushion 14 is positioned over the canopy and stanchions to hold them in position and protect them. The mounting straps 16 hold the pillow and canopy construct in place. The humps of the ribs 30, 32 assist in holding the pillow in position. The mounting straps are tightened against the elements of the sun shade for easy carrying and transport of the sun shade. The sun shade may be easily transported by grasping one or both of the hand holds 20.

The stanchions 6 are defined to be arcuate. The stanchions form an arc along their length as shown in the drawing figures, without having any sharp angles or other impediments along their length that would be likely to prevent easy sliding of the canopy 4. The accurate stanchions allow the canopy to slide along the stanchions to adjust the length of the sides of the canopy as desired. The stanchions are preferred to be made of a material so that they are flexible, so that they may be configured in various positions in the ribs 30,32 as described herein and packed as shown in FIG. 11. The stanchions are detachably positioned in the receptacle apertures 42,44,46,48 so that the stanchions are held within the receptacle apertures in use, but will slide out of the receptacle apertures for repositioning in other receptacle apertures as described herein for modifying the positions of the canopy.

The canopy is preferred to be formed of a textile, a textile blend, or woven or non-woven material. The ends of the canopy may be folded and sewn so as to form channel 24 at each end of the canopy through which the arcuate stanchions are inserted. The canopy slides on the arcuate stanchions and allows variation in the length of the canopy.

The base 2 is preferred to constructed of a rigid but lightweight material, such as molded plastic materials. The base is preferred to have a cutout or void 50 that is covered by pillow 14 when the sun shade so that a hard surface of the base is not under a substantial portion of the pillow. The base should not be present under at least one third (⅓) of the surface of the pillow that is opposite the back panel 12, with the pillow covering the base from the front edge to the back edge and the area from rib 30 to rib 32. Stanchion 26 can be inserted through apertures 52 in the pillow to hold the pillow in place while the canopy is in use, particularly where the sun shade is mounted at an angle, such as on a lounge chair.

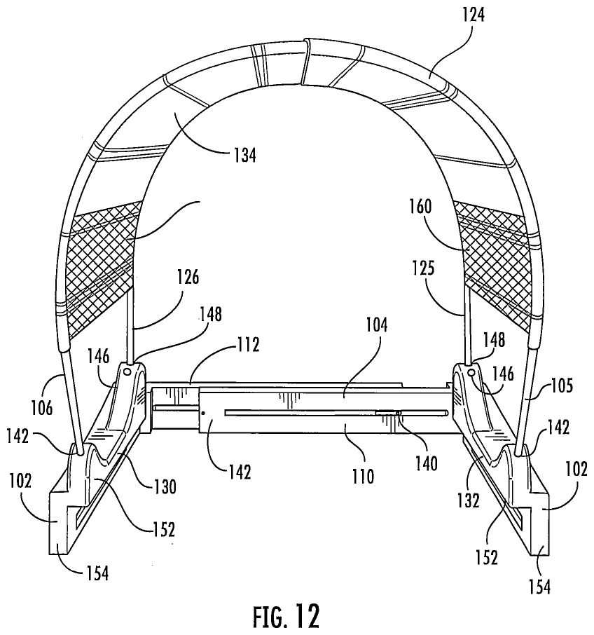

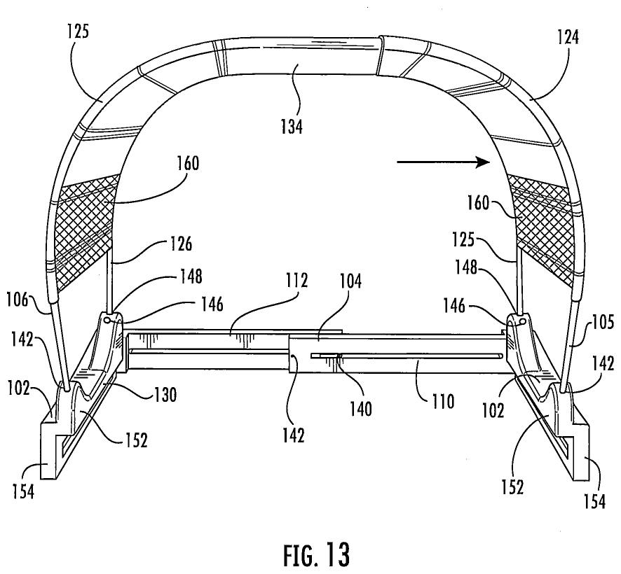

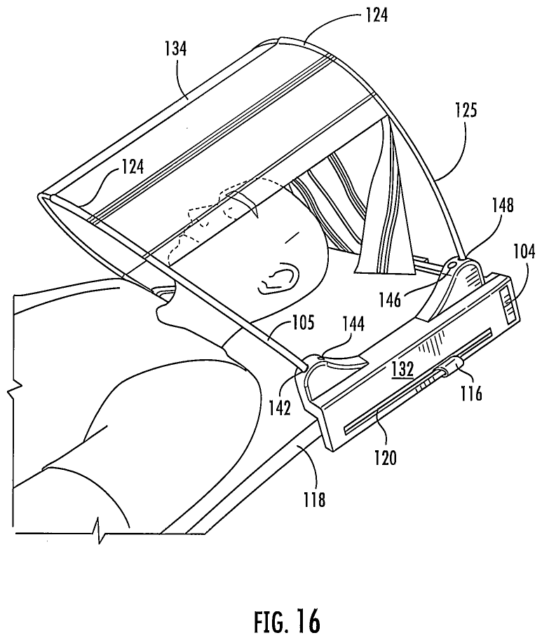

In the embodiment of the base 102 shown in FIGS. 12 and 13, a back member 104 is length adjustable so that the width of the sun shade is adjustable for various applications. For example, the sun shade is usable with beach chairs or lounge chairs or similar seating (FIG. 16). However, not all chairs have the same width at the point of attachment. Base 102 is width adjustable to adapt to different applications. FIG. 12 shows the sunshade with the back member in a retracted position to reduce width of the base, while FIG. 13 shows the base of the sun shade in a width expanded position. The width is user selectable according to user preferences or application requirements.

Length adjustment of the back member may be accomplished by having a first member 110 that is moveable or slidable relative to a second member 112. As shown, the members forming the back member may be slotted, with a locking pin 140 present within the slots. The locking pin is unlocked while the device is being adjusted, and secured when the desired width of the base is achieved. The locking pin could be a thumb screw or other fastener. A pin 142 may be present in first member 110 that extends into the slot of the second member 112 to keep the first member and the second member generally parallel to each other. The pin 142 may be present in either first or second member and extend into the slot of the other member. The first member and the second member slide relative to each other to adjust the width of the sun shade. The structure of the embodiment of the back member shown in the drawings is not intended to be limiting. It is only necessary that the back member is length adjustable to provide variable width of the base of sun shade. Similarly, the locking member shown in the drawings is not intended to be limiting. Securing and permitting length adjustment may be accomplished by devices other than a thumb screw. For example, the first member and second member may be in a telescoping relationship, with one member inserted into the other. A rotatable cuff may be used to lock the position and release the position of the first and second member, or a locking ring may be used if the first member and second member of the back member are tubular structures.

The arcuate canopy stanchions 205, 106, 125, 126 must also be length adjustable to accommodate the width adjustment of the base. FIG. 12; FIG. 13. The stanchions may be formed in two parts, with one of the stanchions inserted into the other stanchion. The two parts of the stanchions are slidable relative to each other to retract or expand the overall length of the stanchions. The connection of the stanchions is preferred to be at about the midpoint of the overall length of the stanchions, which is at a the top portion of the canopy 134 when the sun shade is assembled. Each part of each stanchion is preferred to be of about the same length. The stanchions are slidable within channels 124 of the canopy, which accommodates the adjustable and changeable length of the stanchions.

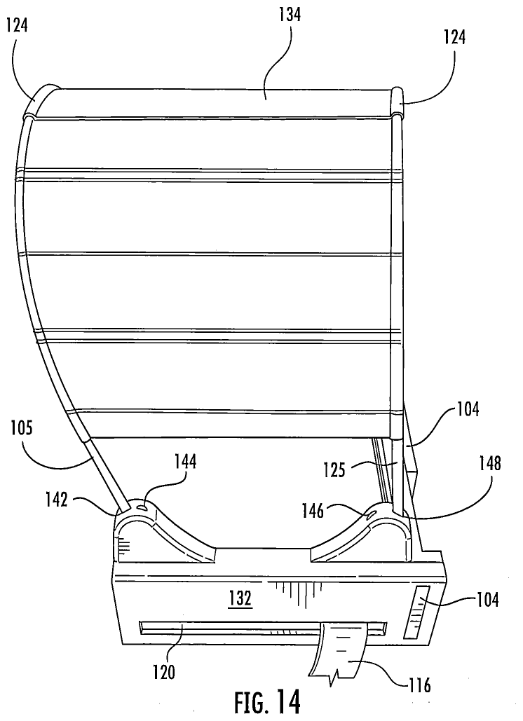

Ends 105, 106 of the first arcuate stanchion and ends 125,126 of the second arcuate stanchion extend through channels 124 formed in the canopy. The canopy is elevated above the base 102 and is supported by the first arcuate stanchion and the second arcuate stanchion. As shown in FIGS. 12 and 13, an end of a first part 106, 126 of each arcuate stanchion is held within a receptacle aperture 142,148 of a first arm 130 of the base. An end 105, 125 of a second part of each arcuate stanchion is held within a receptacle aperture 142,148 of a second arm 132 of the base. Each arm has at least three (3) stanchion receiving apertures. As shown in the drawings, two apertures 142, 144 are formed at the front of each arm and two apertures 146,148 are formed at the rear of each arm. FIG. 14.

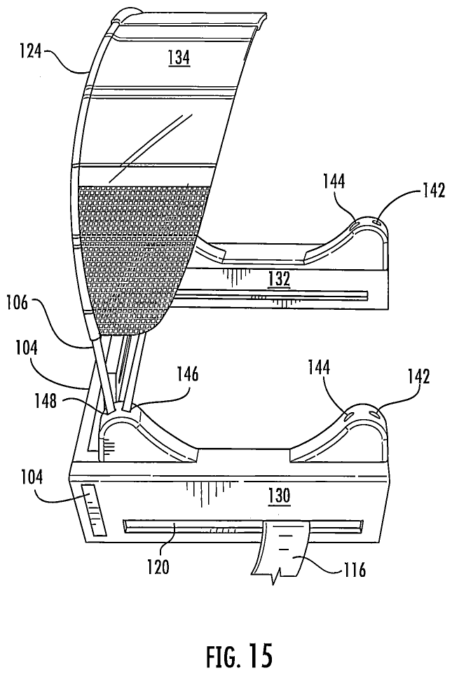

Positioning of the arcuate stanchions within the receptacle apertures is user selectable so that shading or coverage of the user by the canopy may be varied. Examples of variable positioning of the stanchions and canopy by user selection of the apertures. In FIG. 14, apertures 142 and 148 are selected. In FIG. 15, apertures 146,148 are selected, providing different coverage of the canopy over the base as compared to FIG. 14.

The first arm 130 of the base and the second arm 132 of the base are substantially parallel to each other. The arms are connected to each other by the back member 104, which may join each arm at about a right angle. The back member may be inserted at each end into a void formed in the arms. Hand holds 120 are preferred to be formed in one or both arms for carrying the sunshade and for adjusting the strap 116 location.

A strap 116 may extend through the hand holds 120 from one arm 130 to the opposite arm 132 and that is useful for connecting the sun shade to other objects, such as chairs. FIG. 16. Humps 132 may be formed in each arm, with one hump near a front of each arm and another hump formed near a rear of each arm. The apertures 142 may be formed in the humps.

The base 102 may be formed to have an upper inboard portion 152, and a lower outboard portion 154 that are in a step like relationship. FIG. 12. A lower surface of the upper inboard portion may rest upon a top surface of a chair 118 or chair frame, while an inner surface of the lower outboard portion may be pulled against a side of the chair or chair frame with the strap 116 holding the sunshade base in position on a chair, for example. FIG. 16. The strap may extend from a handhold in arm 130 to the handhold in arm 132. The strap is positioned underneath the chair 118, pulled tight, and secured. The base is thereby clamped against the chair frame. The base structure may be used to hold the sunshade in position on objects other than chairs that have a suitable structure. The back member 104 may be secured by actuating the locking mechanism 140.

Pockets 160 may be provided on the interior of the canopy 134. The pockets may be formed of a mesh material that is attached to the canopy. Accessories such as a pillow may be provided for the user's head.

What is claimed is:

1. A portable sun shade, comprising:
a base, the base comprising a first rib and a second rib that is positioned generally parallel to the first rib, each rib including upwardly extending humps at a front and rear end of the base with a reduced portion therebetween, at least one hump of each rib comprising a plurality of receptacle apertures, and wherein a rear member of the connects the first rib to the second rib, and wherein the rear member is constructed and arranged to variably adjust a distance from a first rib to a second rib;
a canopy having a first arcuate stanchion extending through the canopy and a second arcuate stanchion extending through the canopy, the canopy being elevated above the base and supported by the first arcuate stanchion and the second arcuate stanchion, wherein a first end of the first arcuate stanchion is held within a receptacle aperture of the first rib and a second end of the first arcuate stanchion is held within a receptacle aperture of the second rib, and a first end of the second arcuate stanchion is held within a receptacle aperture of the first rib and a second end of the first second stanchion is held within a receptacle aperture of the second rib, and
wherein positioning of the arcuate stanchions within the receptacle apertures is user selectable so that shading or coverage of the user by the canopy may be varied.

2. The portable sun shade as described in claim 1, wherein the first arcuate stanchion and the second arcuate stanchion are each constructed and arranged to provide length adjustment of the stanchions.

3. The portable sun shade as described in claim 1, wherein each hump of each rib comprises a plurality of receptacle apertures.

4. The portable sun shade as described in claim 1, wherein a receptacle aperture of the first rib is formed at an angle of 20 to 40 degrees from vertical, and a corresponding receptacle aperture of the second rib is formed at an angle of 20 to 40 degrees from vertical.

5. The portable sun shade as described in claim 1, wherein the canopy is slidable along the first arcuate stanchion and the second arcuate stanchion, and the canopy of the sun shade is increasingly opened on a side there of as the canopy slides along the stanchions.

6. The portable sun shade as described in claim 1, wherein the canopy comprises a rear covering that extends from the second arcuate stanchion.

7. The portable sun shade as described in claim 1, wherein the first arcuate stanchion is positioned to extend the canopy outwardly and beyond the front of the base.

8. The portable sun shade as described in claim 1, wherein the canopy covers a first side of the sun shade, a second side of the sun shade, and a rear of the sun shade, and the sun shade comprises a front opening.

9. The portable sun shade as described in claim 1, further comprising straps that are positioned through a void formed in the first rib and a void formed in the second rib.

10. The portable sun shade as described in claim 1, wherein the first arcuate stanchion and the second arcuate stanchion are each formed in two parts that are joined together and the stanchions are constructed and arranged to each provide length adjustment of the stanchions by relative positioning of the two parts of the stanchions.

11. A portable sun shade, comprising:
a base, the base comprising a first rib and a second rib that is positioned generally parallel to the first rib, each rib comprising a plurality of receptacle apertures;
a canopy having a first arcuate stanchion extending through the canopy and a second arcuate stanchion extending through the canopy, the canopy being elevated above the base and supported by the first arcuate stanchion and the second arcuate stanchion, wherein a first end of the first arcuate stanchion is held within a receptacle aperture of the first rib and a second end of the first arcuate stanchion is held within a receptacle aperture of the second rib, and a first end of the second arcuate stanchion is held within a receptacle aperture of the first rib and a second end of the first second stanchion is held within a receptacle aperture of the second rib, and
wherein positioning of the arcuate stanchions within the receptacle apertures is user selectable so that shading or coverage of the user by the canopy may be varied.

12. The portable sun shade as described in claim 11, wherein a rear member of the base connects the first rib to the second rib, and wherein the rear member is constructed and arranged to variably adjust a distance from a first rib to a second rib.

13. The portable sun shade as described in claim 11, wherein the first arcuate stanchion and the second arcuate stanchion are each constructed and arranged to provide length adjustment of the stanchions.

14. The portable sun shade as described in claim 11, wherein a receptacle aperture of the first rib is formed at an angle of 20 to 40 degrees from vertical, and a corresponding receptacle aperture of the second rib is formed at an angle of 20 to 40 degrees from vertical.

15. The portable sun shade as described in claim 11, wherein the canopy is slidable along the first arcuate stanchion and the second arcuate stanchion, and the canopy of the sun shade is increasingly opened on a side there of as the canopy slides along the stanchions.

16. The portable sun shade as described in claim 11, wherein the canopy comprises a rear covering that extends from the second arcuate stanchion.

17. The portable sun shade as described in claim 11, wherein the first arcuate stanchion is positioned to extend the canopy outwardly and beyond the front of the base.

18. The portable sun shade as described in claim 11, wherein the canopy covers a first side of the sun shade, a second side of the sun shade, and a rear of the sun shade, and the sun shade comprises a front opening.

19. The portable sun shade as described in claim 11, further comprising straps that are positioned through a void formed in the first rib and a void formed in the second rib.

20. The portable sun shade as described in claim 11, wherein the first arcuate stanchion and the second arcuate stanchion are each formed in two parts that are joined together and the stanchions are constructed and arranged to each provide length adjustment of the stanchions by relative positioning of the two parts of the stanchions.
